(19) United States
(12) Patent Application Publication
(10) Pub. No.: US 2021/0253116 A1
(43) Pub. Date: Aug. 19, 2021

(54) SYSTEM AND METHOD FOR ENHANCING SENSOR OPERATION IN A VEHICLE

(71) Applicant: OSR ENTERPRISES AG, 6330 Cham (CH)

(72) Inventors: Yosef BEN-EZRA, Petah Tikva (IL); Samuel (Semi) HAZAK, Holon (IL); Shai NISSIM, Tel Aviv (IL)

(73) Assignee: OSR ENTERPRISES AG, 6330 Cham (CH)

(21) Appl. No.: 16/972,642

(22) PCT Filed: Jun. 10, 2018
(86) PCT No.: PCT/IL2018/050630

§ 371 Date: Dec. 7, 2020

(51) Int. Cl. B60W 50/029; B60W 50/02; H04L 9/32

(52) U.S. Cl. CPC B60W 50/029; B60W 50/0225; B60W 50/0205; H04L 2209/38; B60W 2050/0292; B60W 2050/0215; H04L 9/3236

(57) ABSTRACT

A method, apparatus and computer program product, the method comprising: receiving sensory information from at least one sensor associated with a vehicle; determining partial hostility level associated with the at least one sensor or the sensory information; based on the hostility level, determining a change in operation of the at least one sensor or analysis of the sensory information; and adapting at least one configuration parameter of the sensor in accordance with the change, thereby reducing the hostility level.

### TECHNICAL FIELD

The present disclosure relates to sensory information associated with a vehicle in general, and to enhancing the sensor operation and utilization in a hostile environment, in particular.

### BACKGROUND

Modern cars, including human operated and particularly autonomous cars, carry a variety of sensors used for capturing aspects of the car, the driver, other passengers, the internal environment of the car, the external environment, including ambient parameters, other vehicles and sensory information related thereto, or the like. Multiple types of information are received from these sensors, including for example distances from stationary objects, distances from other vehicles and moving objects such as pedestrians. Further information may be received from external sources, such as sensors associated with other vehicles, stationary sensors, services, or the like.

Some received information may be of high quality, e.g., accurate and helpful. Other information, however, may be obtained under hostile conditions, including for example interference between radars, optical images taken in foggy weather or other optical disturbances, or the like.

In addition, some information may be intentionally wrong and misleading, for example created and provided by a virus-struck sensor of the vehicle, of another vehicle, or a stationary sensor. For example, a sensor installed on a car may report that the road ahead is clear, while in reality a truck is approaching the car. Using such erroneous information may lead to disastrous results to the car or to other cars receiving this information.

### BRIEF SUMMARY

One exemplary embodiment of the disclosed subject matter is a computer-implemented method for utilizing sensor information related to a vehicle, to be performed by a device comprising a processor and a memory device, the method comprising: receiving sensory information from one or more sensors associated with a vehicle; determining partial hostility level associated with one or more of the sensors or the sensory information; based on the hostility level, determining a change in operation of or more of the sensors or analysis of the sensory information; and adapting one or more configuration parameters of the sensors in accordance with the change, thereby reducing the hostility level. The method can further comprise: receiving second sensory information from one or more second sensors associated with the vehicle; and determining global hostility level associated with the sensors or the second sensors, wherein the change in operation of the sensors or analysis of the sensory information is determined based also on the global hostility level. The method can further comprise: receiving third sensory information from one or more sensors not associated with the vehicle; and determining an integrity level of the third sensory information, wherein subject to the integrity level exceeding a second threshold, the change in operation of the sensors or analysis of the sensory information is determined based also on the third sensory information. Within the method, determining the integrity level of the second sensory information, is performed by multiple vehicles. Within the method, determining the integrity level of the second sensory information, is optionally performed using blockchain computation. Within the method, the third sensory information is optionally received from a source selected from the group consisting of: a cloud computing platform; infrastructure computing platform; and a service. Within the method, the change is optionally selected from the group consisting of: ignoring sensory information received from the sensors or from another sensor; changing a behavior of the vehicle; changing computing resource allocation between sensors, to thereby reduce the hostility level or improve performance; and receiving data from more or fewer sensors. Within the method, receiving data from more or fewer sensors optionally comprises activating or deactivating a drone in a vicinity of the vehicle. Within the method, the sensory information is optionally selected from the group consisting of: geographic location of the vehicle or of another vehicle, location of the one or more of the sensors on the vehicle; weather information; environmental interaction; hazard warnings based on statistics; hazard warning based on pre-defined conditions; computing requirements; and data integrity information.

Another exemplary embodiment of the disclosed subject matter is a computerized apparatus having a processor, the processor being configured to perform the steps of: receiving sensory information from one or more sensors associated with a vehicle; determining partial hostility level associated with the sensors or the sensory information; based on the hostility level, determining a change in operation of one or more of the sensors or analysis of the sensory information; and adapting one or more configuration parameters of the sensors in accordance with the change, thereby reducing the hostility level. Within the apparatus, the processor is optionally further configured to: receive second sensory information from one or more second sensors associated with the vehicle; and determine global hostility level associated with the sensors or the second sensors, wherein the change in operation of the sensors or analysis of the sensory information is determined based also on the global hostility level. Within the apparatus, the processor is optionally further configured to: receive third sensory information from one or more sensors not associated with the vehicle; and determine an integrity level of the third sensory information, wherein subject to the integrity level exceeding a second threshold, the change in operation of the sensors or analysis of the sensory information is determined based also on the third sensory information. Within the apparatus, determining the integrity level of the second sensory information, is optionally performed by multiple vehicles. Within the apparatus, determining the integrity level of the second sensory information, is optionally performed using blockchain computation. Within the apparatus, the third sensory information is optionally received from a source selected from the group consisting of: a cloud computing platform; infrastructure computing platform; and a service. Within the apparatus, the change is optionally selected from the group consisting of: ignoring sensory information received from the sensors or from another sensor; changing a behavior of the vehicle; changing computing resource allocation between sensors, to thereby reduce the hostility level or improve performance; and receiving data from more or fewer sensors. Within the apparatus, receiving data from more or fewer sensors optionally comprises activating or deactivating a drone in a vicinity of the vehicle. Within the apparatus, the sensory information is optionally selected from the group consisting of: geographic location of the vehicle or of another vehicle, location of the one or more sensors on the vehicle; weather information; environmental interaction; hazard warnings based on statistics; hazard warning based on pre-defined conditions; computing requirements; and data integrity information.

Yet another exemplary embodiment of the disclosed subject matter is a computer program product comprising a non-transitory computer readable storage medium retaining program instructions configured to cause a processor to perform actions, which program instructions implement: receiving sensory information from one or more sensors associated with a vehicle; determining partial hostility level associated with one or more of the sensors or the sensory information; based on the hostility level, determining a change in operation of the sensors or analysis of the sensory information; and adapting one or more configuration parameters of the sensor in accordance with the change, thereby reducing the hostility level. |Within the computer program product, the program instructions optionally further implement: receiving second sensory information from one or more second sensors associated with the vehicle; and determining global hostility level associated with the sensors or the second sensors, wherein the change in operation of the sensors or analysis of the sensory information is determined based also on the global hostility level.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic drawing demonstrating a need for assessing and improving hostility of a vehicle environment towards one or more sensors;

FIG. 2 is a schematic block diagram of an embodiment of an apparatus for assessing and improving the hostility of a vehicle environment towards one or more sensors, in accordance with some embodiments of the disclosure; and

FIG. 3 is a schematic flowchart of a method for assessing and improving the hostility of a vehicle environment towards one or more sensors, in accordance with some embodiments of the disclosure.

### DETAILED DESCRIPTION

The term “hostility” used herein is to be widely construed to cover any type of interference to the operation of one or more sensors, or to a car, including but not limited to: inhibiting a sensor associated with a vehicle from noticing an object due to presence of blocking objects between the vehicle and the object; affecting data provided by a sensor due to the presence of other sensors in the environment; making data output by a sensor irrelevant or useless, due for example to weather conditions; hard driving conditions due to bad road condition, difficult road, bad weather, or the like. Hostility can be the result of other sensors, other systems in the vehicle or in other objects, environmental conditions; user behavior, or others.

The term “integrity” used herein is to be widely construed to cover any type of providing data by one or more modules, wherein the modules may be one or more sensors associated with a vehicle, e.g. installed in the vehicle or external thereto, sensors or other modules associated with another vehicles, modules whose output is provided by communication for example from a cloud, or any other information source, in accordance with the design of the module, without intentional or unintentional malfunction or misleading, which causing the provisioning of erroneous or other harmful data or instructions.

Modern vehicles, including human operated as well as autonomous cars, receive information from a multiplicity of sensors, including sensors installed on or within the vehicle, sensors installed on or within other vehicles and whose output is received directly or from a cloud, infrastructure or stationary sensors whose output is received directly or from a cloud, services providing sensory information directly or from a cloud, or others. The sensory data may be received from the external sources using any wired or wireless communication network, channel or protocol. The sensors thus provide aspects of the vehicle, the driver, other passengers, the internal environment of the car, the external environment, ambient parameters, other vehicles and sensory information related thereto, or the like. Such sensors may include but are not limited to any one or more of the following: a camera; a thermal camera; a voice capturing device; a video camera; a radar; a Lidar; a global positioning system (GPS) device; a temperature sensor; a humidity sensor; or the like. Some sensors associated with the vehicle may be external to the vehicle, for example a drone operated for a period of time and scanning the area surrounding the vehicle.

Each sensor has its own advantages and disadvantages which may vary in different situations such as different location, weather conditions, road condition, traffic load and others.

However, some sensors may interfere with other sensors, thus creating a hostile environment which in turn disturbs in generating correct instructions for the vehicle. The hostility towards one or more such sensors may be referred to as noise, and the relation, which may be the ratio (but can also be other mathematical relation) between the interference and the intensity or confidence of the reading may be referred to as signal to noise (SNR) ratio. Such interferences may include, for example, some vehicles blocking the field of view of other vehicles; interferences to radars or LIDARs by radars or LIDARs of nearby vehicles, mountain slope interfering with distance reading, foggy weather interfering with optical cameras or video cameras, or the like.

One technical problem dealt with by the disclosed subject matter is the need to assess the hostility of the environment towards any one or more sensors or a combination thereof, wherein the environment may include the physical and computing environment of the vehicle, and wherein the hostility may change over time and location. The hostility level can change in accordance with the advantages and disadvantages of each sensor in different situations like location, weather and other conditions. Additionally or alternatively, some sensors can interfere with other sensors. Such interference by the environment, by other sensors, or by other factors may be related to as noise. Thus, it may be required to provide an expression of the hostility rating for one or more sensors within the vehicle or external to it, or a combination thereof. The hostility rating may be calculated in real-time or near real-time, such that it reflects the momentary situation.

Another problem addressed by the disclosure relates to assessing the integrity level of the information received from various sensors, including the data received from sensors external to the vehicle, when the environment is hostile and such information is required and received. If one or more sensors are intentionally or unintentionally providing erroneous or otherwise harmful data, or if the integrity of the data cannot be verified, then the data may be regarded cautiously.

Yet another problem addressed by the disclosure relates to the need to adapt the computing of the vehicle and environment situation to the hostility of the environment and the integrity of the received information, to enhance security of the vehicle, its passengers and other objects, as well as to utilize the available resources well.

One technical solution of the disclosure relates to estimating the hostility of the environment towards one or more sensors. In some embodiments, the assessment can take the form of assessing for each sensor its effectivity, expressed for example as a ratio between the quality, intensity or confidence of the data provided by the sensor, and the noise level, e.g. the interference of the environment or other sensors to the sensor. The total hostility of the environment may be assessed as a combination of the hostility of the various sensors, for example a weighted combination.

Another technical solution of the disclosure comprises the determination of the integrity level of data provided by one or more sensors and in particular sensors external to the vehicle. The integrity level may be evaluated, for example, by comparing information received from one or more sensors, such as sensors measuring the same size or factor and associated with different cars, sensors associated with one or more cars vs. fixed sensors, using external information such as weather report to verify indications, or the like.

Yet another technical solution of the disclosure comprises determining one or more changes or adaptations in the operation of one or more of the sensors, or analysis of the sensory information. The changes may comprise changing the calibration or operation parameters of one or more sensors, for example changing capturing parameters of a camera or a radar, such as a capturing angle, lighting settings. Additionally or alternatively, adaptation may comprise changing the analysis of the data received from various sensors, for example, by ignoring or reducing the importance of data received from a sensor towards which the environment is highly hostile, sensors whose output seems to have low value or low integrity may be ignored, or the like. Additionally or alternatively, adaptation may comprise making better utilization of computing resources. For example, in foggy weather, the resources that may be routed to operating an optical camera and analyzing its output may be directed instead towards another sensor, such as a thermal camera. In situations where the integrity of one or more sensors is low, further sensors of types other than the suspected ones may be activated, or the like. In another example, in difficult driving conditions, data from more sensors may be used, thus providing for better decision making.

One technical effect of the disclosure relates to reducing or compensating for the environment hostility, and improving the data provided to a driver or the data upon which the car behavior is determined, thus reducing the vulnerability and increasing safety of the vehicle, its passengers, or other objects in the environment, such as other vehicles, their passengers, pedestrians, or other objects in the environment.

Another technical effect of the disclosure comprises high utilization of the computing or other resources, by activating a required number and types of sensors, or by routing the resources to sensors whose output is of low noise and is assessed as having high integrity.

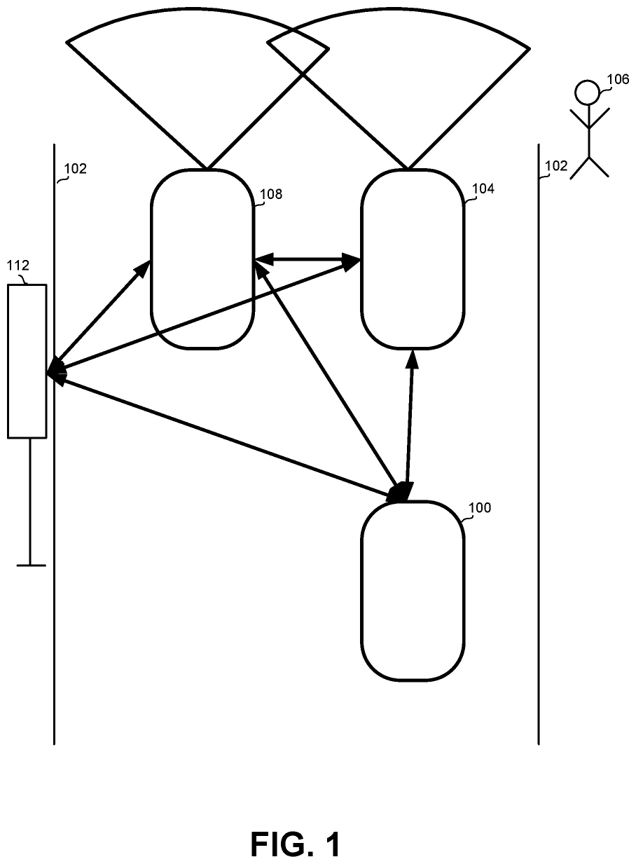

Referring now to FIG. 1, showing a schematic drawing demonstrating a need for assessing and improving hostility of a vehicle environment towards one or more sensors.

FIG. 1 shows a car 100 driven, for example autonomously, in a road part surrounded by tunnel walls 102. The presence of cars 104 and 108, and tunnel walls 102, prohibit radars or cameras of car 100 from noticing pedestrian 106 using. In addition, the significantly different lighting conditions between the tunnel and the area outside the tunnel may cause delays in identifying objects external to the tunnel once the car 100 exits the tunnel. Thus, the environment may be considered hostile towards the sensors and towards car 100. A system within car 100 configured to collect sensory data may therefore issue a request to neighboring vehicles, such as vehicles 104 or 108, or to stationary sensors such as sensor 112 or broadcast a request for relevant information. In particular, data from vehicles or objects external to the tunnel may be of particular significance. Sensors associated with vehicle 104 or 108 or sensor 112, such as radars or cameras may provide information to the system within car 100. The system may then validate the integrity of the received data. If, for example, all three sensors report an object, such as pedestrian 106, car 100 may be driven to avoid the pedestrian, for example its speed may be significantly reduced. If all three sensors report a clear road, car 100 may be driven under the assumption that the road is indeed clear. If one sensor reports an object while two others report clear road, car 100 may be driven in a more cautious manner to avoid possible dangers, without knowing exactly whether and where such danger may be present. If two sensors report an object while the third sensor reports clear road, data provided by the third sensor may be ignored and car 100 may be driven under the assumption that there is an object I the location indicated by the two sensors.

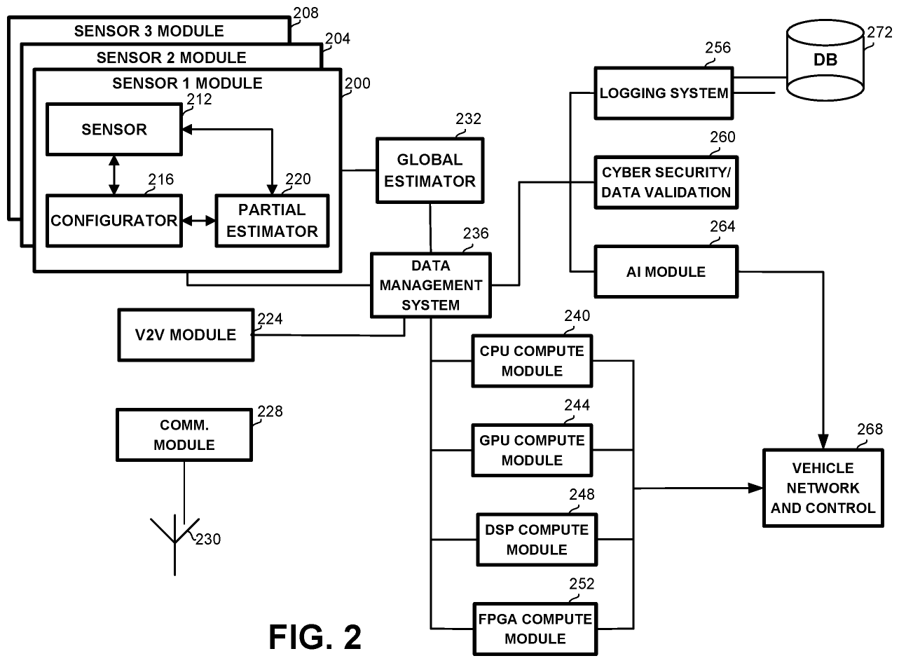

Referring now to FIG. 2, showing a schematic block diagram of an embodiment of an apparatus for assessing and reducing the hostility of a vehicle environment towards one or more sensors.

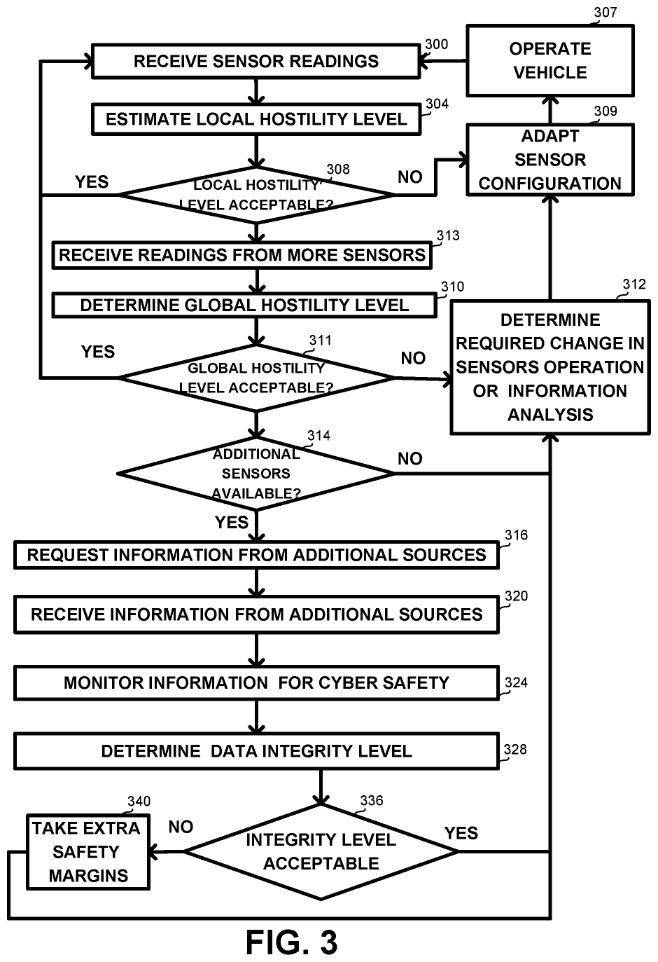

Some components of the apparatus, such as the sensors, may be installed in a vehicle. One or more of the processing elements described below may also be installed in the vehicle. Some components, such as processing elements, may be in use by the vehicle for other purposes, while one or more may be dedicated for processing one or more steps as detailed for example in FIG. 3 below. One or more further elements including additional sensors or processing elements may be installed in other locations, such as another car or a stationary location, and may communicate with components in the vehicle using any wireless communication channel and protocol.

The apparatus may comprise one or more sensor modules, such as sensor module 200, sensor module 204, or sensor module 208. It will be appreciated that the number of sensor modules is not limited to three, rather any number of sensor modules may be installed and used. Each sensor module, such as sensor module 200, may comprise sensor 212, such as a camera, a radar, or the like, configurator 216 and partial estimator 220.

Configurator 216 may submit one or more instructions to sensor 200 to change any of its parameters, for example lighting level or field depth in the case of a camera, scanning angle or radiated intensity in the case of a radar, or the like.

Partial estimator 220 may estimate the hostility level of the environment towards sensor 212. The hostility level may be defined as a ratio or another relation between the positive contribution of the data provided by the sensor, for example the confidence in its results or the importance of the data (for example a front radar may be more important than a rear one), and the noise interfering with the sensor. The noise may take into account any one or more of the following parameters, and optionally additional ones:
L—The geographic location of the vehicle;
SL—The sensor location on the vehicle;
I—Environment interaction;
W—Weather indicators, including for example parameters indicating fog, rain, snow, or the like;
S—Hazard rating based on statistics and/or predefined warnings, related to the location, to the car, or the like;
N—Information received from friendly systems, such as a certified weather channel, navigation systems providing information about road blockage or conditions;
HS—Information about hostile sensors, such as a sensor intentionally providing erroneous information.

In addition, the following factors may be considered:
C—computing needs;
D—data integrity.

It will be appreciated that the hostility level per each sensor is time dependent, and may thus be defined as:

$$\frac{{S}_{sensor}}{{N}_{sensor}} ( {X}_{z} , T )$$

Wherein Xs (L, SL, I, W, S, N, HS, C) represents a complex function of partial hostility to the individual sensor, T represents time, S represents the signal, e.g., the contribution of the information from the sensor, and N represents the noise, e.g. the interferences.

A loop between sensor 212, partial estimator 220 and configurator 216 provides for ongoing sensing, hostility estimation of the sensor, and adaptation of the sensor based on the hostility level.

Information from all sensor modules 200, 204, 208 may be provided to global estimator 232. Global estimator 232 may combine the partial hostility levels as provided by the sensor modules into a general hostility level. The combination may be a defined as a sum of the separate hostility levels, a weighted sum, or the like, for example:

$$\frac{{S}_{radar}}{{N}_{radar}} ( {X}_{1} , T ) + \frac{{S}_{Lidar}}{{N}_{Lidar}} ( {X}_{2} , T ) + \frac{{S}_{Cameras}}{{N}_{Cameras}} ( {X}_{3} , T ) + … . \frac{{S}_{n}}{{N}_{n}} ( {X}_{n} , T ) = R$$

wherein R is the global hostility level, and N is the number of sensors considered. Global estimator 232 may use one or more additional parameters, such as but not limited to compute needs of the vehicle, general data integrity information or requirements, or the like.

In some embodiments, partial estimator 220 may be omitted, such that the hostility level per sensor is also computed by global estimator 232.

The overall hostility level as computed by global estimator 232 may be provided to data management system 236 and examined there. For example, it may be determined whether the hostility level is acceptable, e.g. exceeds a predetermined threshold, in which case one or more actions need to be taken.

Data management system 236 may provide the collected data and/or the hostility levels to logging system 256, for purposes such as monitoring, learning, compliance with legal requirements or the like. Logging system 256 may store the data in database 272 which may be located within the vehicle or external thereto, for example on a cloud computing device.

Data management system 236 or other modules may use any one or more available computing resources, such as CPU compute module 240, GPU compute module 244, DSP compute module 248, FPGA compute module 252, or the like, which may be installed in the vehicle or at a remote location. Any one of the compute modules may be a dedicated module, or installed for additional/other purposes or shared by other processes, and used by the current apparatus. Any of the compute modules may be configured to perform blockchain computations. I block chain computation, the same computation is carried out by multiple processing units, which may be positioned in multiple vehicles or other locations. Thus, together with computing modules of other vehicles a situation related to a state reported by multiple sensors can be agreed upon, and all vehicles may react in accordance with the agreed upon situation. For example, all computing modules may agree that there is an object, possibly a pedestrian at certain coordinates, that the two cars at certain coordinates are at a distance of 4 feet apart, or the like.

Data management system 236 may provide the collected data and/or the hostility levels to cyber security/data validation module 260. Cyber security/data validation module 260 may monitor all sensory data or other information received from sources external to the vehicle for cyber security, i.e. verify that the data, regardless of its content, is not harmful to the vehicle or any of its systems.

Cyber security/data validation module 260 may validate the integrity of the data provided by the various sources such as sensor modules 200, 204 or 208, or data provided by V2V module or communication module 228 as detailed below. The integrity determination may be based on worst case scenario, for example if even one sensor out of at least a predetermined number of sensors indicates a danger, then the danger is assumed to exist, on a majority voting, or the like. The integrity of data from any source may be evaluated using the hostility level associated with the source, or the like.

Data management system 236 may provide the collected data and/or the hostility levels to AI module 264, for purposes such as learning, adapting the hostility computation determination process, adapting the integrity level determination process, or the like.

If data management system 236 determines that the hostility level is unacceptable, for example exceeds a threshold, it can issue a request for additional sensory data from other vehicles or infrastructures.

Thus, global estimator 232 may also receive information from sensors associated with other vehicles, through vehicle-to-vehicle (V2V) module 224. The information may include the raw output of the sensor, wherein the hostility level associated with the sensor may be computed by estimator general 232. Additionally or alternatively, the hostility level associated with the sensor may be provided with the data provided by V2V module 224.

Additionally or alternatively, global estimator 232 may also receive information from other sources, such as infrastructure, cloud, or the like through communication module 228 being in communication with at least one antenna 230. It will be appreciated that multiple components in the system may communicate with other modules through communication module 228, however the relevant connecting lines have been omitted for clarity purposes. The hostility level of information provided by communication module 228 may be computed by estimator general 232. Additionally or alternatively, the hostility level associated with information provided by communication module 228 may be provided with the data.

Data management system 236 or global estimator 232 may determine, optionally using any of the computing devices detailed above, upon the hostility level and the integrity levels associated with different sensors, one or more commands to be provided to different components in the system, in order to change their behavior. For example, one or more commands may be provided to configurator 216 of sensor 1 module 200 (or the other sensor modules) to change the operational parameters of sensor 212, the sensor behavior, or the like. Additionally or alternatively, data management system 236 or global estimator 232 may change the algorithm or the parameters of computing the hostility levels, the hostility threshold, the algorithm or the parameters of determining the integrity level, for example determining to ignore certain sensors or sensor types. Additionally or alternatively, data management system 236 or global estimator 232 may send one or more commands to vehicle network and control module 268 configured to adapt the behavior of the vehicle, for example instruct the relevant vehicle systems to reduce speed, increase speed, stop, change lane, blow the horn, start the wipers, or take any other action. The instructions may also be logged, together with indications from the vehicle systems or from sensors in logging system 256.

Referring now to FIG. 3, showing a generalized flowchart of a method for assessing and improving the hostility of a vehicle environment towards one or more sensors.

On step 300, one or more sensor readings, such as readings from sensor 212, may be received, for example by sensor module 200, 204 or 208 installed within or on a vehicle.

On step 304, the partial hostility level associated with each sensor may be determined, as detailed in association with partial estimator 220. It will be appreciated that partial relates to referring to a single or a group of interrelated sensors.

On step 308 it may be determined whether the partial hostility level is acceptable. Acceptable may refer to whether the sensor is operating in a hostile environment which limits its ability to provide accurate or useful information. Acceptability may refer to a value representing the partial hostility level being below a predetermined threshold, wherein the threshold may depend on the circumstances, such as road type, weather, time of day, driver details if known, or the like.

If the partial hostility level does not exceed the threshold, then there is no need for an action other than the usual, and the loop may continue in receiving further sensor readings on step 300.

If the partial hostility level exceeds the threshold, then on step 309 the sensor configuration may be adapted, for example by changing at least one configuration parameter of the sensor, to reduce the hostility level. The sensor configuration may be changed by configurator 216, in accordance with a change determined by partial estimator 220, configurator 216 or another module.

On step 313, information may be received from further sensors within or associated with the vehicle, such as additional cameras, Radars, Lidars, drones, or the like.

Whether the partial hostility level is acceptable or not, a global hostility level as based on a data from the multiplicity of sensors may be determined on step 310.

On step 307, the vehicle may be operated or controlled in accordance with the input as received from the sensor(s). However, in some embodiments, control commands may only be issued following input from the sensors after the sensors had been adapted and not based on the previous sensor reading. The control commands may change the behavior of the vehicle, for example increasing or reducing the speed, turning, switching lanes, or the like.

On step 311, it may be determined whether the global hostility level is acceptable. Acceptable may refer to whether the total sensor system in or associated with the vehicle is operating in a hostile environment which limits its ability to provide accurate or useful information. Acceptability may be determined as a value representing the global hostility level being below a predetermined threshold, wherein the threshold may depend on the circumstances, such as road type, weather, time of day, driver details if known, or the like.

If the global hostility level exceeds the threshold, then on step 312, a required change to the operation of the sensors within or associated with the vehicle may be determined, for example: changing operation parameters of one or more sensors; activating or deactivating sensors; changing the allocation of computing resources between sensors, for example giving more resources to more critical sensors or to sensors suffering from lower hostility; changing the hostility level computation parameters, or the like. In some examples, the change may include starting or stopping to operate a drone in the area of the vehicle. This change may include or be followed by further adaption of the configuration of one or more sensors on step 309, and vehicle operation and control on step 307.

Whether the global hostility level is acceptable or not, it may be found out on step 314, for example by data management system 236, whether external sensors exist, such as stationary sensors, sensors in other vehicles, or the like.

If no external sensors exist or no data from additional sensors is available, then execution may return to step 312, in which changes are determined to the sensors operation or other information analysis.

If external sensors exist, then on step 316 a request for information may be sent to such sensors, or broadcast and received by relevant sensors. The request may be sent or broadcast by communication module 228.

On step 320, information may be received from the one or more external sensors. The information may include the readings, and may also include parameters as detailed above, which may be relevant to assessing the respective hostility levels.

On step 324, the data received from the external sensors may be monitored for cyber security, using for example firewall, antivirus, or other tools, such that information that is suspected as being harmful will not enter the vehicle or any of its systems. The data may be monitored by cyber security/data validation module 260.

On step 328, the integrity level of the data accumulated from all sources may be validated, for example by cyber security/data validation module 260 or by AI module 264. Validation can be performed by blockchain computations, such that multiple entities, for example computing units of multiple vehicles, perform the computations. The blockchain computation provides for hosting past information in a reliable and unchangeable manner, which thus provides high level of integrity.

On step 336, it is determined whether the integrity level, as determined on step 328, possibly by multiple vehicles, is acceptable. For example, acceptable may refer to exceeding a threshold, wherein the threshold may be dynamic and may depend on factors such as the road type, the driver, the weather, time of day, or the like.

If the integrity level is below a threshold, then on step 340 extra safety margins or operations may be taken by the vehicle, since it is unclear which information is genuine and which is malicious. Such operations may include significantly reducing speed, halting, or the like. Execution may then return to step 312, in which the sensor operation and configuration, and vehicle operation depend only on the sensors associated with the vehicle.

If the integrity level exceeds the threshold, then execution may return to step 312, in which the sensor operation and configuration, and vehicle operation depend also on information received from the external sensors or sources.

Additionally or alternatively, additional changes may be determined, such as sharing information with other platforms for example other vehicles or services, including providing or receiving data; dividing tasks between vehicles; keeping the blockchain activity, or the like.

Thus, steps 312 may determine required changes in sensor operation or data analysis, in accordance with internal or external sensors if any are available and of high integrity, and in accordance with data form internal sources only if no external ones are available, or they are of low integrity.

It will be appreciated that the method may operate in several nested loops. Thus, the partial hostility estimation and sensor adaptation may repeat constantly, at a predetermined frequency. In addition, possibly at a lower frequency, the general hostility level may be determined, and the sensors behavior or data analysis may be changed accordingly. Moreover, the adaptation of a single sensor behavior may take into account the previous global hostility level and required adaptations. In a further loop, which may be of even lower frequency, the availability and integrity of external sensors may be determined, and the sensor operations and data analysis may be configured accordingly.

It will be appreciated that the method may be executed in an ongoing loop, intended for constantly monitoring the received data, and making the required changes for improving safety and efficiency. The method and apparatus promote the computer resource allocation within each vehicle, and the cooperation between vehicles for receiving a more accurate mapping of the environment, while optimizing resources division, thus making better usage of the available resources, and reducing the environmental hostility for multiple vehicles.

The disclosed method and apparatus thus provides for making changes within the vehicle or with the environment to make the environment less hostile, thus making better use of the available information and increasing safety and efficiency.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). Each block may be implemented as a multiplicity of components, while a number of blocks may be implemented as one component. Even further, some components may be located externally to the car, for example some processing may be performed by a remote server being in computer communication with a processing unit within the vehicle. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of utilizing sensor information related to a vehicle, to be performed by a device comprising a processor and a memory device, the method comprising:
receiving sensory information from at least one sensor associated with a vehicle;
determining partial hostility level associated with the at least one sensor or the sensory information;
based on the hostility level, determining a change in operation of the at least one sensor or analysis of the sensory information; and
adapting at least one configuration parameter of the sensor in accordance with the change,
thereby reducing the hostility level.

2. The method of claim 1, further comprising:
receiving second sensory information from at least one second sensor associated with the vehicle; and
determining global hostility level associated with the at least one sensor or the at least one second sensor,
wherein the change in operation of the at least one sensor or analysis of the sensory information is determined based also on the global hostility level.

3. The method of claim 1, further comprising:
receiving third sensory information from at least one sensor not associated with the vehicle; and
determining an integrity level of the third sensory information, wherein subject to the integrity level exceeding a second threshold, the change in operation of the at least one sensor or analysis of the sensory information is determined based also on the third sensory information.

4. The method of claim 3, wherein determining the integrity level of the second sensory information, is performed by multiple vehicles.

5. The method of claim 4, wherein determining the integrity level of the second sensory information, is performed using blockchain computation.

6. The method of claim 3, wherein the third sensory information is received from a source selected from the group consisting of: a cloud computing platform; infrastructure computing platform; and a service.

7. The method of claim 1, wherein the change is selected from the group consisting of: ignoring sensory information received from the at least one sensor or from another sensor; changing a behavior of the vehicle; changing computing resource allocation between sensors, to thereby reduce the hostility level or improve performance; and receiving data from more or fewer sensors.

8. The method of claim 7 wherein receiving data from more or fewer sensors comprises activating or deactivating a drone in a vicinity of the vehicle.

9. The method of claim 1, wherein the sensory information is selected from the group consisting of: geographic location of the vehicle or of another vehicle, location of the at least one sensor on the vehicle; weather information; environmental interaction; hazard warnings based on statistics; hazard warning based on pre-defined conditions; computing requirements; and data integrity information.
A computer program product comprising a computer readable storage medium retaining program instructions, which program instructions when read by a processor, cause the processor to perform a method comprising:

10. A computerized apparatus having a processor, the processor being configured to perform the steps of:
receiving sensory information from at least one sensor associated with a vehicle;
determining partial hostility level associated with the at least one sensor or the sensory information;
based on the hostility level, determining a change in operation of the at least one sensor or analysis of the sensory information; and
adapting at least one configuration parameter of the sensor in accordance with the change,
thereby reducing the hostility level.

11. The apparatus of claim 10, wherein the processor is further configured to:
receive second sensory information from at least one second sensor associated with the vehicle; and
determine global hostility level associated with the at least one sensor or the at least one second sensor,
wherein the change in operation of the at least one sensor or analysis of the sensory information is determined based also on the global hostility level.

12. The apparatus of claim 10, wherein the processor is further configured to:
receive third sensory information from at least one sensor not associated with the vehicle; and
determine an integrity level of the third sensory information, wherein
subject to the integrity level exceeding a second threshold, the change in operation of the at least one sensor or analysis of the sensory information is determined based also on the third sensory information.

13. The apparatus of claim 10, wherein determining the integrity level of the second sensory information, is performed by multiple vehicles.

14. The apparatus of claim 10, wherein determining the integrity level of the second sensory information, is performed using blockchain computation.

15. The apparatus of claim 10, wherein the third sensory information is received from a source selected from the group consisting of: a cloud computing platform; infrastructure computing platform; and a service.

16. The apparatus of claim 10, wherein the change is selected from the group consisting of: ignoring sensory information received from the at least one sensor or from another sensor; changing a behavior of the vehicle; changing computing resource allocation between sensors, to thereby reduce the hostility level or improve performance; and receiving data from more or fewer sensors.

17. The apparatus of claim 16, wherein receiving data from more or fewer sensors comprises activating or deactivating a drone in a vicinity of the vehicle.

18. The apparatus of claim 10, wherein the sensory information is selected from the group consisting of: geographic location of the vehicle or of another vehicle, location of the at least one sensor on the vehicle; weather information; environmental interaction; hazard warnings based on statistics; hazard warning based on pre-defined conditions; computing requirements; and data integrity information.

19. A computer program product comprising a non-transitory computer readable storage medium retaining program instructions configured to cause a processor to perform actions, which program instructions implement:
receiving sensory information from at least one sensor associated with a vehicle;
determining partial hostility level associated with the at least one sensor or the sensory information;
based on the hostility level, determining a change in operation of the at least one sensor or analysis of the sensory information; and
adapting at least one configuration parameter of the sensor in accordance with the change,
thereby reducing the hostility level.

20. The computer program product of claim 19, wherein the program instructions further implement:
receiving second sensory information from at least one second sensor associated with the vehicle; and
determining global hostility level associated with the at least one sensor or the at least one second sensor,
wherein the change in operation of the at least one sensor or analysis of the sensory information is determined based also on the global hostility level.
